(19) United States
(12) Patent Application Publication
(10) Pub. No.: US 2021/0387739 A1
(43) Pub. Date: Dec. 16, 2021

(54) PROPULSION SYSTEM FOR AN AERIAL VEHICLE

(71) Applicant: William J. Neff, Sandy, UT (US)

(72) Inventor: William J. Neff, Sandy, UT (US)

(21) Appl. No.: 17/459,938

(22) Filed: Aug. 27, 2021

Related U.S. Application Data
(63) Continuation-in-part of application No. 16/206,862, filed on Nov. 30, 2018, now Pat. No. 11,117,658.

(51) Int. Cl. B64D 27/24; B64C 29/00; B64C 37/00; B60F 5/02; A63H 29/24; A63H 17/26

(52) U.S. Cl. CPC B64D 27/24; B64C 29/0033; A63H 17/262; B60F 5/02; A63H 29/24; B64C 37/00

(57) ABSTRACT

A propulsion system for an aerial vehicle or toy aerial vehicle includes a bladeless fan drive and a peripheral ground-engagement part. The bladeless fan drive operates in a plane (x′-y′) and is configured for producing thrust. The peripheral ground-engagement part comprises a hubless wheel and a rotatable tire component. The bladeless fan drive is secured within the hubless wheel by two pivot points on opposing sides of the bladeless fan drive, such that the plane of the bladeless fan drive is pivotable about a pivot axis (x′) spanning between the two pivot points, the pivot axis (x′) being orthogonal to a hubless wheel axis (z) of the peripheral ground-engagement part.

### CROSS-REFERENCE TO RELATED APPLICATIONS

This application is a continuation in part of U.S. patent application Ser. No. 16/206,862, filed Nov. 30, 2018, entitled “Propulsion System for an Aerial Vehicle,” the entire content of which is incorporated herein by this reference.

### BACKGROUND

### 1. Technical Field

This disclosure relates to propulsion systems for aerial vehicles, manned or unmanned, which have the capability of traveling on the ground or in the air.

### 2. Related Technology

Currently, the principal approaches for practical vertical-takeoff-and-landing (VTOL) flight vehicles can be grouped into three broad categories: high-speed vehicles using jet thrust or variations of jet thrust and highly loaded lifting fans (e.g., the Harrier and the JSF/F-35B); medium-speed vehicles with rotors (e.g., helicopters and tilt-rotors); and low-speed lifting fan or ducted fan vehicles with more than one lifting fan (such as a flying platform like the Piasecki Flying Jeep). These approaches have good capabilities in the air, but are not suited for efficient movement on the ground, especially on rough terrain.

In many designs, the propulsion system is used to provide both vertical forces for hover and horizontal forces for forward flight. This can be done by tilting the VTOL propulsion device (e.g., a tilt-rotor) or by providing a separate propulsion device. Some implementations of VTOL aircraft, such as consumer quadcopters or drones, generate horizontal propulsion forces by tilting the entire vehicle. However, these vehicles generally do not perform well on the ground and in the air.

It is therefore desirable to have a vehicle with all-terrain capability on the ground as well as vertical take-off and landing and moving take-off and landing air capabilities.

### BRIEF SUMMARY OF THE INVENTION

The following implementations and aspects thereof are described and illustrated in conjunction with systems, machines, and methods that are meant to be exemplary and illustrative, not necessarily limiting in scope. In various implementations one or more of the above-described problems have been addressed, while other implementations are directed to other improvements.

An example embodiment of the present disclosure provides a propulsion system for a vehicle or toy vehicle comprising a ducted fan or shrouded propeller drive system for driving the vehicle along the ground. The ducted fan or shrouded propeller drive system operates in a section of a wheel or tire and having a peripheral ground-engagement part. The system further comprising a ducted fan or shrouded propeller comprising one or more fan or propeller blades rotatable about a hub or axis for producing thrust. The ducted fan or shrouded propeller drive system and the fan or propeller blades are positioned relative to each other so that during rotation of the fan or propeller blades, the blades pass through the plane of the ducted fan or shrouded propeller system, inside the peripheral ground-engagement part, illustrated herein as a hubless wheel.

In another example embodiment, a propulsion system for an aerial vehicle or toy aerial vehicle includes a bladeless fan drive and a peripheral ground-engagement part. The bladeless fan drive operates in a plane (x′-y′) and is configured for producing thrust. The peripheral ground-engagement part comprises a hubless wheel and a rotatable tire component. The bladeless fan drive is secured within the hubless wheel by two pivot points on opposing sides of the bladeless fan drive, such that the plane of the bladeless fan drive is pivotable about a pivot axis (x′) spanning between the two pivot points, the pivot axis (x′) being orthogonal to a hubless wheel axis (z) of the peripheral ground-engagement part.

Beneficially, the propulsion system according to the disclosure allows for travel on the ground by virtue of the peripheral ground-engagement part and drive mechanism and for travel in the air by virtue of the ducted fan, shrouded propeller, or bladeless fan drive system.

The disclosed embodiments advantageously provide a compact arrangement with the ducted fan, shrouded propeller, or bladeless fan drive system passing through the plane of the rotary peripheral ground-engagement part drive system. Further, in the case of a ducted fan or shrouded propeller, because the fan or propeller blades are inside a duct or shroud and the peripheral ground-engagement part extends around the ducted fan or shrouded propeller drive system to some extent, it protects the fan or propeller blades from contacting external objects as well as reducing noise from the propulsion system. Similarly, because the airfoil of the bladeless fan is at least partially surrounded by the peripheral ground-engagement part, it protects the airfoil from contacting external objects.

The disclosed embodiments also provide a vehicle or a toy vehicle comprising a chassis and one or more propulsion systems as disclosed herein connected to the chassis.

Firstly, in various embodiments, a four-wheeled vehicle (i.e., having four propulsion systems, which can drive as well as fly) and capable of vertical take-off and landing while stopped or while moving. Additionally, in various embodiments, ground travel can be achieved by engaging a rear-wheel-drive system, while the front wheels components remain in neutral or steer.

Additionally, in various embodiments, the power source for the ducted fan, shrouded propeller, or bladeless fan drive system and rotary peripheral ground-engagement part drive system may be mechanically powered (i.e., by a combustion engine causing a shaft to rotate, which in turn through a series of gears, a clutch, universal joints, or otherwise or electrically powered by either or both a battery or rechargeable battery or the drive system may be powered by both a hybrid mechanical and electrical source.

In various embodiments, the ducted fan, shrouded propeller, or bladeless fan drive system may rotate or pivot so it may be in the same plane as the tire or rotary peripheral ground-engagement part drive system and may pivot so it is crosswise or transverse the rotary peripheral ground-engagement part drive system.

In various embodiments, the tire or rotary peripheral ground-engagement part drive system is self-contained in the peripheral ring so as not to interfere with the rotation or pivoting ability of the ducted fan, shrouded propeller, or bladeless fan drive system.

Additional features and advantages of exemplary implementations of the invention will be set forth in the description which follows, and in part will be obvious from the description, or may be learned by the practice of such exemplary implementations. The features and advantages of such implementations may be realized and obtained by means of the instruments and combinations particularly pointed out in the appended claims. These and other features will become more fully apparent from the following description and appended claims, or may be learned by the practice of such exemplary implementations as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. For better understanding, the like elements have been designated by like reference numbers throughout the various accompanying figures. Understanding that these drawings depict only typical embodiments of the invention and are not therefore to be considered to be limiting of its scope, the invention will be described and explained with additional specificity and detail through the use of the accompanying drawings in which:

FIG. 1 is a diagram depicting a possible configuration of an illustrative embodiment of a ducted fan or shrouded propeller drive system rotated or pivoted to be on the same plane as the rotary peripheral ground-engagement part drive system and in which the rotary peripheral ground-engagement part is powered by electric motors attached to the rim.

FIG. 2 is a diagram depicting a possible configuration of an illustrative embodiment of the rotary peripheral ground-engagement part drive system using toothed gears or cogs and a cogged ring on the outer peripheral ground-engagement part to rotate the tire.

FIG. 3 is a diagram depicting a possible configuration of an illustrative embodiment of a ducted fan or shrouded propeller drive system where the rotary peripheral ground-engagement part component is powered through mechanical means, here a drive shaft mechanically powered by an engine and with one end having toothed gears or cogs and a cogged ring on the outer peripheral ground-engagement part to rotate the tire.

FIG. 4 is a diagram depicting a possible configuration of an illustrative embodiment of a ducted fan or shrouded propeller drive system rotated or pivoted to be crosswise the plane of the rotary peripheral ground-engagement part drive system and tilted forward.

FIG. 5 shows an illustrative embodiment of an aerial vehicle with the ducted fan or shrouded propeller drive system in the same plane as the rotary peripheral ground-engagement part drive system and the rotary peripheral ground-engagement part drive system powered by mechanical means.

FIG. 6 shows an illustrative embodiment of an aerial vehicle with the ducted fan or shrouded propeller drive system rotated crosswise for flying position and the rotary peripheral ground-engagement part drive system powered by electrical means.

FIG. 7 is a diagram depicting a partially exploded view of an illustrative embodiment of a bladeless fan drive system.

### DETAILED DESCRIPTION

Aside from the example embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. Moreover, any claims are not to be read restrictively unless there is clear and convincing evidence manifesting a certain exclusion, restriction, or disclaimer.

Although specific features of the disclosed embodiments are shown in some drawings and not in others, this is for convenience only as each feature may be combined with any or all of the other features in accordance with the present disclosure. The words “including”, “comprising”, “having”, and “with” as used herein are to be interpreted broadly and comprehensively and are not limited to any physical interconnection. Moreover, any embodiments disclosed herein are not to be taken as the only possible embodiments. Other embodiments will occur to those skilled in the art.

One or more embodiments of a ducted fan, shrouded propeller, or bladeless fan drive system and rotary peripheral ground-engagement part drive system can be used in aerial vehicles to overcome the weight of the vehicle and load necessary to provide lift and airborne maneuvering capabilities.

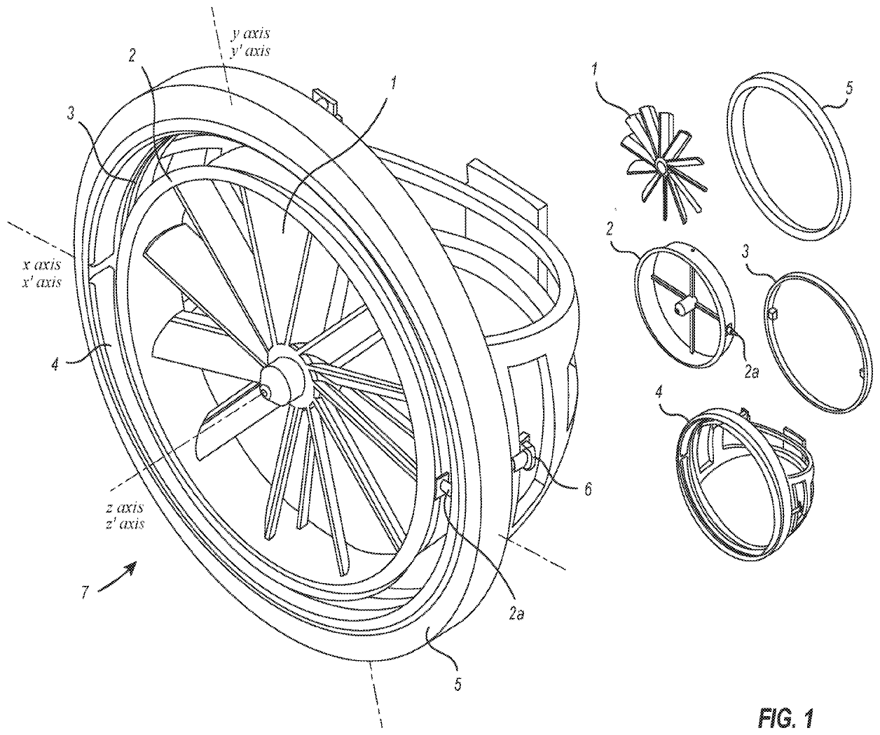

FIG. 1 is a diagram depicting separate components and a possible configuration of the components in an illustrative embodiment of a ducted fan or shrouded propeller drive system rotated or pivoted to be on the same plane as the rotary peripheral ground-engagement part drive system. The propulsion system shown here comprises the fan or propeller blades 1 which affix to a hub 2 in the duct for the fan or shroud for the propeller, as it is generally called depending on the number of rotor blades involved, which is attached to gimbal or pivot points 2a on a ring 3 that allows the duct/shroud 2 to rotate about a pivot axis (x′) that is defined by the pivot points 2a and fixed relative to the ring 3. The ring 3 can also be caused (e.g., by mechanical or electrical means such as a servo motor) to tilt or rotate forward or backward on the y-axis. The ring 3 is contained inside the peripheral ground-engagement part drive system 4 (here simply expressed as a hubless rim or hubless wheel) which also attaches to the body of the vehicle and which contains a rotatable tire 5 which can rotate by mechanical or electrical power 6 around the hubless wheel axis (z). The entire drive system is identified here by reference number 7.

The propulsion system also has a ducted fan or shrouded propeller rotatable around its hub's axis (z′). The ducted fan or shrouded propeller axis (z′) lies in center of the hubless wheel axis (z) and can rotate to be in the same plane within the rim of the hubless wheel or crosswise or perpendicular to the hubless wheel axis (z). In this diagram it depicts the position of the ducted fan when the vehicle is on the ground or engaged in ground travel. Since the ducted fan or shrouded propeller drive and the hubless wheel may be running at the same time, the ducted fan may rotate while the hubless wheel is being powered and moving along the ground. Therefore, the ducted fan can rotate on its axis (z′) and start spinning and the vehicle can go from ground travel to air travel seamlessly without having to bring the vehicle to a stop and then start the aerial capabilities of the vehicle.

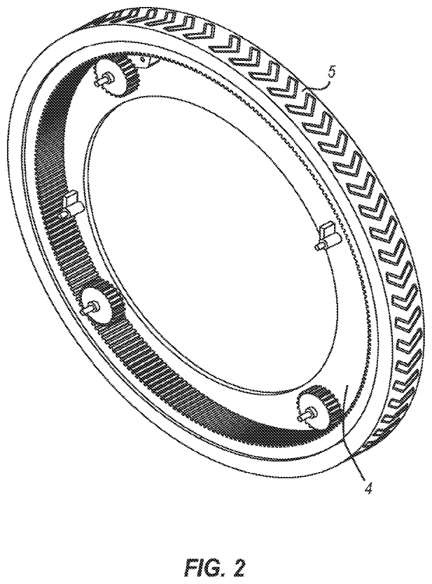

FIG. 2 is a diagram depicting a possible configuration of an illustrative embodiment of the rotary peripheral ground-engagement part drive system 4 in which the hubless wheel is using toothed gears or cogs and the rotatable tire 5 comprises a cogged ring on the inner part. This allows the rotatable tire 5 component of the peripheral ground-engagement part 4 to turn while the inside is attached to the vehicle. It is understood the drive system may use outward facing cogged ring or wheels on tension or friction to contact and cause the tire 5 component of the outer peripheral ground-engagement part 4 to rotate. In some embodiments (not shown), the illustrated hubless wheel design is adapted to create a ducted fan or shrouded propeller drive system comprising rim-driven or hubless ducted fans or rim-driven or hubless shrouded propellers inside the hubless wheel. In is understood that alternative known rim-driven or hubless designs of both wheels and ducted fan or shrouded propeller systems may be included in embodiments according to the present disclosure.

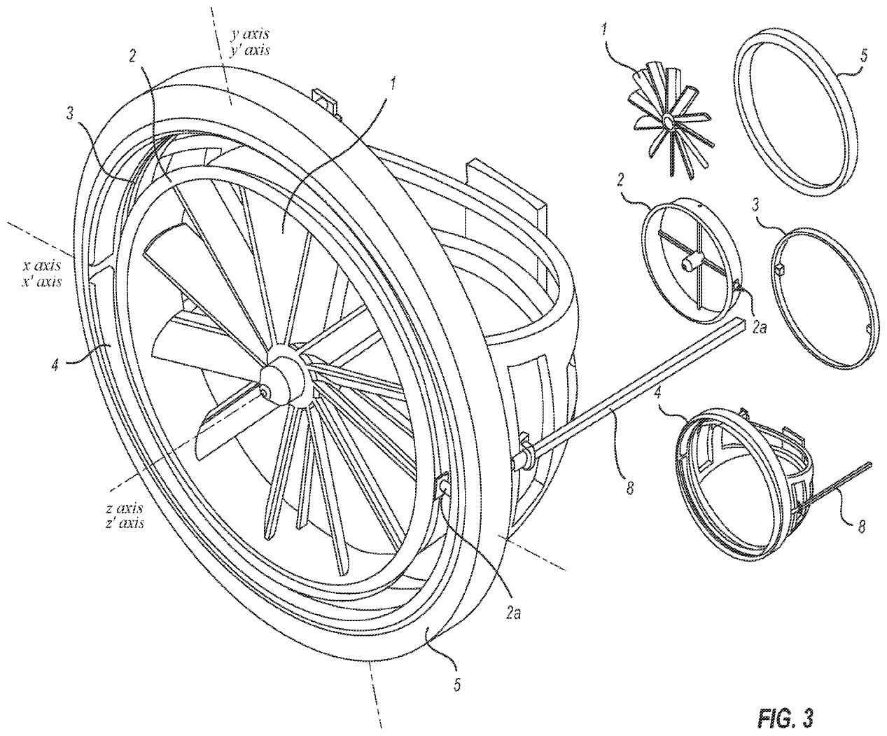

FIG. 3 is a diagram depicting separate components and a possible configuration of the components in an illustrative embodiment of a ducted fan or shrouded propeller drive system rotated or pivoted to be on the same plane as the rotary peripheral ground-engagement part drive system as described in FIG. 1. However, here it shows a mechanically powered drive shaft 8 that rotates the rotatable tire through mechanical means such as friction rollers or toothed gears.

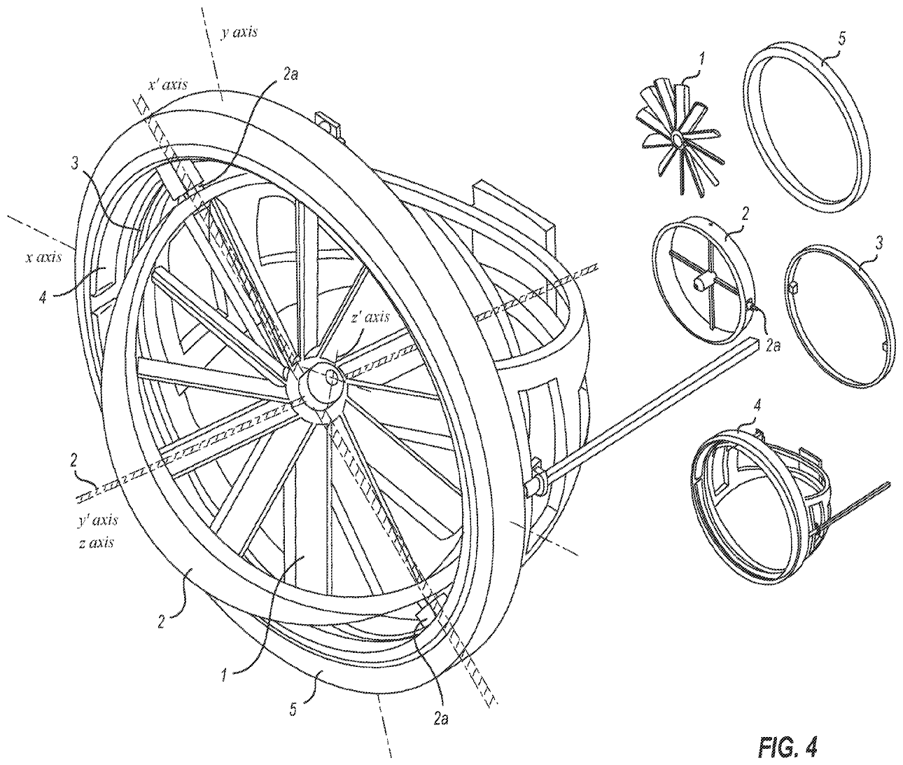

FIG. 4 is a diagram depicting a possible configuration of an illustrative embodiment as described in the preceding paragraph, but where the y′-axis of the ducted fan or shrouded propeller 2 component is rotated or pivoted about the x′-axis thereof to be crosswise the x-axis and y-axis planes of the peripheral ground-engagement part 4, such that the y′-axis of the ducted fan or shrouded propeller component coincides with the z-axis of the hubless wheel, and the z′-axis of the ducted fan or shrouded propeller components in orthogonal to the z-axis of the hubless wheel, which can be done by a servo motor or other device that governs the speed and degree of rotation about the pivot points 2a. This will be the position the ducted fan is in when the aerial vehicle lifts off the ground and while it is airborne. As in a consumer quadcopter drone, most of the maneuvering or steering of the vehicle while in flight will be controlled through the power and speed of each ducted fan; however, tilting the x′-axis of the ducted fan 2a from its horizontal position via rotation of the ring 3 about the z-axis of the hubless wheel to reposition the z′-axis of the ducted fan or shrouded propeller component, as shown, will also add maneuverability features to the aerial vehicle.

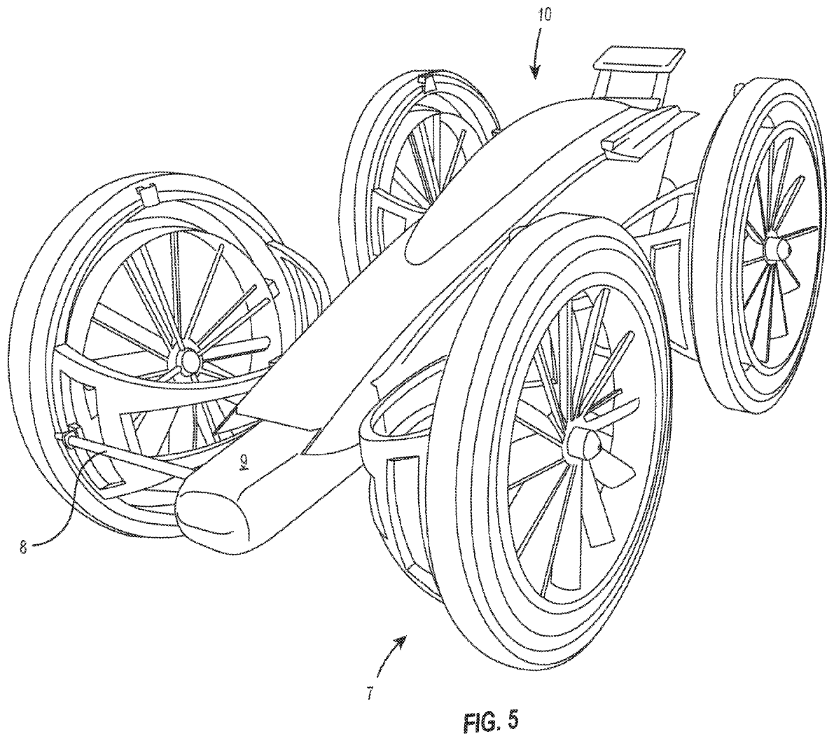

FIG. 5 is a diagram depicting a possible embodiment of an aerial vehicle 10 comprising the ducted fan or shrouded propeller drive system and the rotary peripheral ground-engagement part drive system as described in connection with FIG. 1 as comprising the entire drive system 7. Here, where the outer tire 5 component is rotated and powered by mechanical means. This necessitates a power source 9 (e.g., an engine) and drive shaft 8 to power a contact device (e.g., toothed gears or friction contact wheels) to turn the tire portion 5 of the hubless wheel.

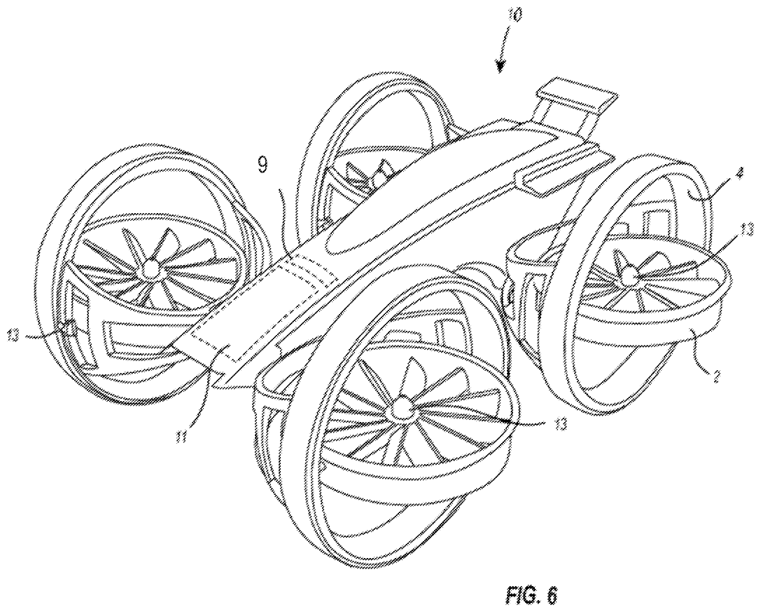

FIG. 6 is a diagram depicting one possible embodiment of an aerial vehicle 10 and a possible configuration of an illustrative embodiment of a ducted fan or shrouded propeller drive system and the rotary peripheral ground-engagement part drive system as described in FIG. 1 powered by electrical means. This necessitates an electric power source 11, e.g., a battery pack or genset engine, with use of an electric speed control (ESC) 9 to govern the amount of power supplied to an electric motor 13. This illustrative embodiment of an aerial vehicle 10 shows the ducted fan or shrouded propeller drive system 2 rotated or tilted to facilitate air travel. This may be accomplished by having a gimbal on a ring between the hubless wheel rim and the ducted fan or shrouded propeller drive system, which allows for the ducted fan to rotate on an axis in a forward and rear direction as well as side to side and by a servo motor or other device that governs the speed and degree of rotation as described above. Additionally, an embodiment could be shown where the entire axle could tilt or rotate forward or backwards at the point where the peripheral ground-engagement part 4 connects to the frame of the aerial vehicle 10 thereby negating the additional gimbal and ring between the hubless wheel and the ducted fan housing.

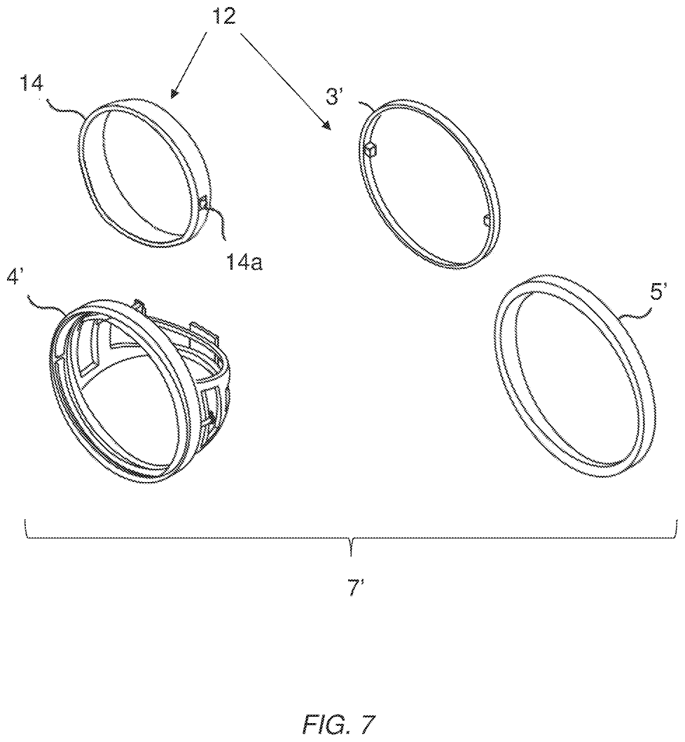

FIG. 7 is a diagram depicting a partially exploded view of an illustrative embodiment of drive system 7′. The drive system 7′ may be similar or identical to the other drive systems disclosed herein. Accordingly, the following discussion of the device system 7′ will focus on the aspects that are unique thereto.

The drive system 7′ includes a rotary peripheral ground-engagement part drive system 4′ that may be similar or identical to the rotary peripheral ground-engagement part drive system 4 and may facilitate movement of a vehicle on the ground. A tire 5′ may be mounted on the rotary peripheral ground-engagement part drive system 4′ and engage the ground.

In contrast to the ducted fan or shrouded propeller systems of the other embodiments, the drive system 7′ includes a bladeless fan drive system 12. The bladeless fan drive system 12 includes a ring 3′ and an airfoil loop 14. The ring 3′ is mountable or otherwise contained inside the peripheral ground-engagement part drive system 4′ similar to the manner in which the ring 3 is contained inside the peripheral ground-engagement part drive system 4.

The airfoil loop 14 is connectable to the ring 3′ via gimbal or pivot points 14a (similar to how the duct/shroud 2 is connected to the ring 3 as described above). The connection between the airfoil loop 13 and the ring 3′ enables the airfoil loop 14 to pivot and move in the same manner as the ducted fan or shrouded propeller systems discussed above.

The airfoil loop 14 may be connected to a supply of moving air or other fluid via a connection as the gimbal or pivot points 14a. The airfoil loop 14 has a generally airfoil or teardrop cross-sectional shape, with a wider rounded edge on one side and a tapered narrow edge on the opposite side. One or more slits or slots are formed in an interior surface of the airfoil loop 14 adjacent to the edge with the wider rounded configuration. Air or other fluid introduced into the airfoil loop 14 via the connection as the gimbal or pivot points 14a passes through the airfoil loop 14 and exits through the slits or slots therein. As a result of entrainment and the Coanda effect, the amount of air moved by the airfoil loop 14 is dramatically higher than the amount of air introduced vie the connection as the gimbal or pivot points 14.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

We claim:

1. A propulsion system for an aerial vehicle or toy aerial vehicle comprising:
a bladeless fan drive, the bladeless fan drive operating in a plane (x′-y′) and configured for producing thrust; and
a peripheral ground-engagement part, the peripheral ground-engagement part comprising a hubless wheel and a rotatable tire component, the bladeless fan drive being secured within the hubless wheel by two pivot points on opposing sides of the bladeless fan drive, such that the plane of the bladeless fan drive is pivotable about a pivot axis (x′) spanning between the two pivot points, the pivot axis (x′) being orthogonal to a hubless wheel axis (z) of the peripheral ground-engagement part.

2. The propulsion system according to claim 1, wherein the rotatable tire component of the peripheral ground-engagement part comprises a tire mounted on a rim portion of the hubless wheel for rotation about the hubless wheel axis (z).

3. The propulsion system according to claim 1, wherein the two pivot points of the bladeless fan drive are secured to a rotatable ring within the hubless wheel, the rotatable ring being configured to rotate about the hubless wheel axis (z), such that the bladeless fan drive may pivot both side to side via the two pivot points and front to back via the rotatable ring, inside the peripheral ground-engagement part.

4. The propulsion system according to claim 3, wherein the pivot axis (x′) intersects a fixed plane (x-y) of the peripheral ground-engagement part.

5. The propulsion system according to claim 3, wherein the pivot axis (x′) lies in the plane (x′-y′) of the bladeless fan drive.

6. The propulsion system according to claim 1, wherein the plane (x′-y′) of the bladeless fan drive and the hubless wheel axis (z) are perpendicular to each other during at least one operational configuration of the propulsion system.

7. The propulsion system according to claim 1, wherein the bladeless fan drive comprises an airfoil loop.

8. The propulsion system according to claim 7, wherein the airfoil loop comprises a rounded edge, an opposing tapered edge, and one or more slits through an interior surface thereof, the one or more slits being disposed adjacent to the rounded edge.

9. The propulsion system according to claim 1, wherein the peripheral ground-engagement part includes a support for attaching a rim portion of the hubless wheel to a vehicle chassis.

10. The propulsion system according to claim 9, wherein the bladeless fan drive is connected to the support via the peripheral ground-engagement part.

11. The propulsion system according to claim 9, wherein the support comprises brackets connected to suspension struts.

12. The propulsion system according to claim 1, further comprising one or more motors for driving the hubless wheel.

13. An aerial vehicle or a toy aerial vehicle comprising:
a chassis and one or more propulsion systems connected to the chassis, each propulsion system comprising:
a bladeless fan drive, the bladeless fan drive operating in a plane (x′-y′) and configured for producing thrust; and
a peripheral ground-engagement part, the peripheral ground-engagement part comprising a hubless wheel and a rotatable tire component, the bladeless fan drive being secured within the hubless wheel by two pivot points on opposing sides of the bladeless fan drive, such that the plane of the bladeless fan drive is pivotable about a pivot axis (x′) spanning between the two pivot points, the pivot axis (x′) being orthogonal to a hubless wheel axis (z) of the peripheral ground-engagement part.

14. The aerial vehicle of claim 13, further comprising one or more additional bladeless fan not inside the hubless wheel, but attached to the aerial vehicle and configured to add additional thrust or lift.

15. The aerial vehicle of claim 13, wherein the bladeless fan drive comprises an airfoil loop.

16. The aerial vehicle of claim 15, wherein the airfoil loop comprises a rounded edge, an opposing tapered edge, and one or more slits through an interior surface thereof, the one or more slits being disposed adjacent to the rounded edge.

17. A propulsion system for a vehicle configured for air and ground travel, the propulsion system comprising:
a peripheral ground-engagement part comprising a hubless wheel and a tire component mounted on the hubless wheel such that the tire component is rotatable about a hubless wheel axis (z); and
bladeless fan drive comprising:
a ring rotatably secured within the hubless wheel of the peripheral ground-engagement part, the ring being rotatable about the hubless wheel axis (z), independent of rotation of the tire component; and
an airfoil loop pivotably secured within the ring, the airfoil loop having at least one pivot point about which the airfoil loop can rotate in relation to the ring about an airfoil loop axis (x′), wherein the airfoil loop axis (x′) is perpendicular to the hubless wheel axis (z) and is fixed in relation to the ring, wherein the airfoil loop is configured to produce thrust.

18. The propulsion system of claim 17, further comprising a grounded configuration wherein a plane of the airfoil loop coincides with a plane or rotation of the hubless wheel.

19. The propulsion system of claim 17, wherein combined rotation of the ring about the hubless wheel axis (z) and the airfoil loop about the airfoil loop axis (x′) enables the bladeless fan drive to rotate in pitch, yaw, and roll relative to the peripheral ground-engagement part.

20. The propulsion system of claim 17, wherein the airfoil loop comprises a rounded edge, an opposing tapered edge, and one or more slits through an interior surface thereof, the one or more slits being disposed adjacent to the rounded edge.
